(19) United States
(12) Patent Application Publication
(10) Pub. No.: US 2026/0291762 A1
(43) Pub. Date: Sep. 24, 2026

(54) UNCLONABLE ELECTRONIC DEVICE FOR PROVIDING A UNIQUE IDENTIFIER OR CERTIFICATE OF AUTHENTICITY

(71) Applicant: YAU YUEN YEUNG, HONG KONG (CN)

(72) Inventors: YAU YUEN YEUNG, HONG KONG (CN); PAK GEI YEUNG, HONG KONG (CN); PAK LAM YEUNG, HONG KONG (CN)

(21) Appl. No.: 19/179,668

(22) Filed: Apr. 15, 2025

Related U.S. Application Data
(60) Provisional application No. 63/653,285, filed on May 30, 2024.

(51) Int. Cl. H04L 9/32; H04L 9/08

(52) U.S. Cl. CPC H04L 9/3278; H04L 9/0863; H04L 9/0866; H04L 9/0869; H04L 9/3228; H04L 9/3239; H04L 9/3242; H04L 9/3263

(57) ABSTRACT

Unclonable electronic device for providing a unique identifier or certificate of authenticity includes: unclonable electronic device for providing a unique identifier or certificate of authenticity, wherein a prototype of the unclonable electronic device comprises an ESP32 or ESP32 compatible micro-controller having a unique chip identity, built-in Wi-Fi and Bluetooth capabilities; and a thin-film transistor display with at least a resolution of 240x240 pixels. When a customer scans an unclonable electronic device to be verified, the server receives a message to be verified. The server generates a one-off password according to the identity of a chip of the unclonable electronic device to be verified. The server verifies whether the one-off password is consistent with the one-time password in the unique identifier or certificate of authenticity by the server; if it is, the verification is successful; if not, the verification fails, and a warning message is sent to the code scanning device.

### CROSS REFERENCE TO RELATED APPLICATIONS

This application claims priority to U.S. Provisional Application No. US63/653,285, entitled “Unclonable Electronic Device For Providing A Unique Identifier or Certificate of Authenticity” filed on May 30, 2024, which is hereby incorporated by reference herein as if set forth in its entirety.

### TECHNICAL FIELD

The present application relates to the technology of anti-counterfeit authentication, and for example, relates to an unclonable electronic device for providing a unique identifier or certificate of authenticity.

### BACKGROUND

Hong Kong has worldwide reputation of being a shopping heaven, especially for her sales of those high-value product or luxury goods like mobile phones, tablets, computers, branded fashions/bags/shoes, artwork, antiques, expensive watches and jewelry etc. and provisions of high-quality services in medical, paramedical, health or beauty areas to many visitors/customers from Mainland China and Southeast Asian countries. To sustain the valuable reputation of Hong Kong and individual shops or service providers, we need to apply various effective technologies to fight against counterfeit and fake products or services.

### SUMMARY

The present application provides an unclonable electronic device for providing a unique identifier or certificate of authenticity, so as to facilitate consumers to perform anti-counterfeiting verification according to the generated unique identifier or certificate of authenticity.

In a first aspect, an embodiment of the present application provides an unclonable electronic device for providing a unique identifier or certificate of authenticity, wherein the unclonable electronic device comprises an ESP32 or ESP32 compatible micro-controller having a unique chip identity, built-in Wi-Fi and Bluetooth capabilities; and a thin-film transistor display with at least a resolution of 240x240 pixels.

In a second aspect, an embodiment of the present application provides a method for generating a unique identifier or certificate of authenticity, and the processing method comprises the following steps: acquiring the identity of the chip when the unclonable electronic device is started; generating a secret key according to a first preset algorithm; generating a decrypted key using the secret key according to a second preset algorithm; generating a session identity, and modifying the decrypted key by using the session identity; generating a pre-one-time password using the decrypted key modified by the session identity according to a third preset algorithm; converting the pre-one-time password into a one-time-password, and generating the unique identifier or certificate of authenticity according to the one-time-password, wherein the unique identifier or certificate of authenticity comprises the identity of the chip, the session identity and the one-time-password.

In a third aspect, an embodiment of the present application further provides a non-volatile computer readable storage medium, storing computer-readable instructions, wherein when the computer-readable instructions are executed by one or more processors, the one or more processors are made to implement the following steps: acquiring the identity of the chip when the unclonable electronic device is started; generating a secret key according to a first preset algorithm; generating a decrypted key using the secret key according to a second preset algorithm; generating a session identity, and modifying the decrypted key by using the session identity; generating a pre-one-time password using the decrypted key modified by the session identity according to a third preset algorithm; converting the pre-one-time password into a one-time-password, and generating the unique identifier or certificate of authenticity according to the one-time-password, wherein the unique identifier or certificate of authenticity comprises the identity of the chip, the session identity and the one-time-password.

### BRIEF DESCRIPTION OF THE DRAWINGS

FIG. 1 is a schematic view of an unclonable electronic device provided according to an embodiment of the present application.

FIG. 2 is a conceptual diagram for the essential mechanisms of unclonable authentication.

FIG. 3 is a flow chart of 11 key steps for the unclonable microcontroller program development.

FIG. 4 is a flowchart diagram of a method for generating a unique identifier or certificate of authenticity provided according to an embodiment of the present application.

FIG. 5 is a flowchart diagram of another method for generating a unique identifier or certificate of authenticity provided according to an embodiment of the present application

FIG. 6 shows a few examples of the unique identifier or certificate of authenticity provided according to the embodiment of the present application being displayed in the form of two-dimensional codes.

FIG. 7 is a flowchart diagram of another method for generating a unique identifier or certificate of authenticity provided according to an embodiment of the present application.

FIG. 8 is a flowchart diagram of another method for generating a unique identifier or certificate of authenticity provided according to an embodiment of the present application.

FIG. 9 is a flowchart diagram of another method for generating a unique identifier or certificate of authenticity provided according to an embodiment of the present application.

FIG. 10 is a flowchart diagram of another method for generating a unique identifier or certificate of authenticity provided according to an embodiment of the present application.

FIG. 11 is a flowchart diagram of a method for anti-counterfeiting verification provided according to an embodiment of the present application.

FIG. 12 is a schematic view of the hardware structure of a chip for executing the method of generating a unique identifier or certificate of authenticity provided according to an embodiment of the present application.

### DETAILED DESCRIPTION

To make the objectives, technical solutions and advantages of the present application clearer, hereinafter the technical solutions of this application will be described clearly and completely through embodiments with reference to the attached drawings in the embodiments of this application. Obviously, the embodiments described herein are only a part of but not all of the embodiments of this application.

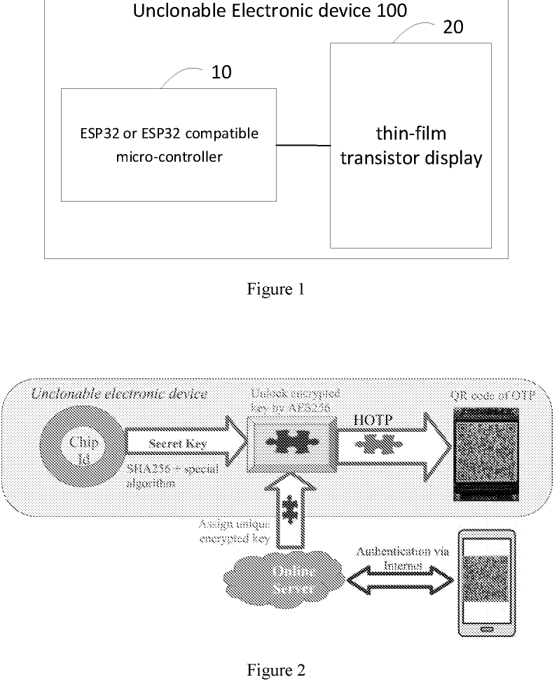

FIG. 1 is a schematic view of an unclonable electronic device for providing a unique identifier or certificate of authenticity provided according to an embodiment of the present application. The technical solution of this embodiment may be applied to anti-counterfeit verification of products, commodities or services, and the unclonable electronic device which may be configured in commodities, suppliers providing the commodities or suppliers providing services.

Referring to FIG. 1, the unclonable electronic device 100 comprises an ESP32 or ESP32 compatible micro-controller 10 and a thin-film transistor display 20. The ESP32 or ESP32 compatible micro-controller has a unique chip identity, built-in Wi-Fi and Bluetooth capabilities. The thin-film transistor display has at least a resolution of 240x240 pixels.

In some embodiments, a thin-film transistor (TFT) display, IPS130 TFT color display is chosen as it has the resolution of 240x240 pixels (physical size of 2.5cm x 2.5 cm) and its unit cost is less than USD2.5.

In some embodiments, the unclonable electronic device further comprises software which is implementable on the micro-controller for generating a secret key using the SHA256 cryptographic algorithm and a specifically developed algorithm as based on the unique chip identity of the ESP32 or ESP32-compatible micro-controller; wherein the software is updatable using over-the-air technology to update the encrypted master key and enable modification of certain key-generation and decryption algorithms and render counterfeit devices obsolete. With the use of the updatable software, the counterfeit devices can be effectively thwarted as the SHA256 cryptographic algorithm can be continually evolved to stay ahead of potential counterfeiters.

In some embodiments, the decryption algorithms comprise the SHA256 cryptographic algorithm.

The SHA256 algorithm is a cryptographic hash function that takes an input message and produces a fixed-size (256-bit) hash value. It is designed to be fast and compute a unique hash for each unique input, making it suitable for data integrity checks, digital signatures, password hashing, and other applications. It is considered secure for most practical purposes. It exhibits several desirable security properties, including pre-image resistance (difficult to find the original input from the hash), second pre-image resistance (difficult to find a different input with the same hash), and collision resistance (difficult to find two different inputs with the same hash).

In some embodiments, the secret key is used for unlocking or decrypting an encrypted master key.

In some embodiments, the software is implemented on the micro-controller for encryption and decryption of the encrypted master key and product information using an AES256 cryptographic algorithm.

The AES256 is a symmetric encryption algorithm that operates on fixed-size blocks of data (128 bits) using a 256-bit encryption key. It employs a series of transformations, including substitution, permutation, and mixing operations, to provide confidentiality and encryption of sensitive information. AES256 is widely used in various applications, such as securing data transmission, protecting stored data, and ensuring secure communication channels. Regarding its security, AES256 is considered secure and has been extensively studied and analyzed by the cryptographic community. It provides a high level of security against known attacks when implemented correctly and using appropriate key management practices. AES256 is resistant to various cryptographic attacks, including brute force attacks, differential cryptanalysis, and linear and algebraic attacks.

In some embodiments, the software utilizes a HMAC (hash-based message authentication code) algorithm for generating a one-time password based on the decrypted master key, an instantaneous value of a time counter and a random number generated from the built-in true random number generator of the ESP32 or ESP32-compatible micro-controller. For authentication, HMAC involves the use of a cryptographic hash function like SHA256 and a secret cryptographic key to simultaneously verify both the data integrity and authenticity of a message. An HMAC is a type of keyed hash function that can also be used in a key derivation scheme or a key stretching scheme. Instead of digital signatures with asymmetric cryptography which requires for a complex public key infrastructure, HMAC just employs a secret key shared just once between two parties. Then, it can be used to generate HMAC-based one-time password (the pre-one-time password) which will then be converted into human readable one-time password (OTP), rendering the so-called Open Authentication (OATH).

In some embodiments, the thin-film transistor display presents a two-dimensional QR code message containing a product identity, the instantaneous value of the time counter, the random number, and the one-time password for authentication purposes. With the QR code displayed, consumers or verifiers can scan the QR code using their smartphones or dedicated scanning devices to verify the authenticity of the product, commodity, or service.

In some embodiments, the unclonable electronic device further comprises an online server for recording device-related information, including the chip identity, the product identity, and the encrypted master key for each ESP32 or ESP32-compatible micro-controller.

In some embodiments, the online server generates the secret key to decrypt the encrypted master key during an authentication process using the chip identity and a specific algorithm which can be modified but must be aligned with the one used in the unclonable electronic device for decrypting the encrypted master key. The online server also plays a crucial role in managing and verifying the authenticity of the electronic devices. By storing the chip identity, product identity, and encrypted master key, the server can cross-reference this information when a device attempts to authenticate. If the information matches what is stored on the server, the device is deemed authentic. This process adds an extra layer of security, as it ensures that even if a counterfeit device manages to replicate some aspects of the genuine device, it will still fail the authentication process without the correct information stored on the server.

In some embodiments, the online server authenticates a device by comparing a calculated one-time password with the submitted one-time password; wherein the online server calculates the calculated one-time password using the decrypted master key of the device together with the submitted product identity and the time counter. If the calculated one-time password matches the submitted one-time password, the device is authenticated successfully. If not, the authentication fails, indicating a potential counterfeit or unauthorized device.

In some embodiments, the online server provides further information about the product if the authentication is successful. The provided further information can facilitate consumers' understanding of the product.

In the prior art, the printing and production of anti-counterfeit labels or implementing authentication methods for industrial or commercial products involve various technologies and approaches. The current situation of the well-accepted or emerging technologies and related challenges or risks are concisely summarized as follows:
(a) Holograms: Until most recently, it is a common practice to employ holographic labels or features to provide a visually striking and difficult-to-replicate authentication method. As based on the physical principles of light, they often incorporate 3D images, optical phenomena, and light diffraction patterns. Nowadays, sophisticated counterfeiters may try to reproduce holograms, and recent advancements in holographic printing have rendered it quite difficult to ensure foolproof authenticity.
(b) Security Inks: Based on materials science, special inks are used for authentication as they can that show unique properties under certain conditions. For example, thermochromic inks will exhibit color change for temperature variations, and ultraviolet (UV)-reactive inks can emit light when shone by UV light. Since these inks can be replicated by counterfeiters, it is highly necessary to make continuous innovation to develop new ink formulations and detection methods.
(c) QR Codes and Barcodes: As being widely employed for product identification and tracking, implementing unique QR (Quick Response) codes or barcodes on products will enable authentication and traceability. However, counterfeiters can easily replicate or tamper with QR codes and barcodes unless there are other robust security measures and verification processes simultaneously adopted.
(d) RFID: RFID (Radio Frequency Identification) tags are made from small electronic devices that can wirelessly transmit information when interrogated by a reader. They enable real-time tracking, inventory management, and authentication. However, for effective anti-counterfeit implementation, it is crucially necessary to ensure secure encryption and protection against cloning or unauthorized access.
(e) NFC: NFC (Near Field Communication) technology allows wireless communication between devices in close proximity. It is commonly used in contactless payment systems but can also be employed for product authentication. Similar to RFID, secure encryption and protection against cloning are essential for reliable anti-counterfeit measures.
(f) Blockchain Technology: Decentralized and immutable ledgers by blockchain can also allow for product authentication and traceability. Security against counterfeiting is enhanced by recording product information and transactions in a transparent and tamper-proof manner. However, there are still many technological and logistical challenges to overcome before implementing blockchain solutions at scale and integrating them into existing supply chains.
(g) Physically Unclonable Functions (PUFs): They can ensure device uniqueness because they are security primitives that make use of the inherent uniqueness of physical properties in electronic devices to generate unique, unpredictable, and unclonable identifiers or cryptographic keys. They can be employed to ensure the authenticity of products by embedding PUFs in integrated circuits or physical tags. PUFs rely on the variability of manufacturing processes, physical characteristics, or environmental conditions to create device-specific responses that cannot be reproduced or replicated. Apart from being complicated for implementation, they are also encountered with certain critical problems or limitations such as sensitivity to environmental factors, potential reliability challenges, and the need for careful integration and design considerations. Therefore, it still requires many ongoing research and advancements to address these limitations and further enhance the effectiveness and robustness of PUF-based security systems.

Challenges in anti-counterfeit measures of the prior art include the need for continuous innovation to stay ahead of counterfeiters, ensuring cost-effectiveness and scalability, establishing standardized authentication methods, addressing privacy concerns, and educating consumers about authentication techniques. Besides, the effectiveness of anti-counterfeit measures often relies on a combination of multiple technologies and approaches to create layered security and make counterfeiting economically unviable.

Comparing with the above-mentioned existing technologies, the present disclosure is found to possess the following advantages:
(i) it is very easy to develop and manufacture as its constituent hardware mainly consists of a micro-controller and a thin-film-transistor liquid-crystal display.
(ii) it is very simple for any mobile phone user to use (just scan the QR code and then browse the website).
(iii) it is very cost-effective (around USD$7 or less each) for authentication of individual high-end products or the retailer of low-price items.
(iv) it is unclonable and highly secure as its underlying cryptographic algorithms have never been cracked before.
(v) there is no need to spend a huge amount of resources and research efforts to make continuous innovation for improvement of the anti-counterfeiting technology to fight against counterfeiting.

Referring to FIG. 2, The unclonable electronic device can generate a secret key using the SHA256 cryptographic algorithm and a specifically developed algorithm as based on the unique chip identity of the ESP32 or ESP32-compatible micro-controller, wherein the secret key is used for unlocking or decrypting an encrypted master key by AES256. HOTP is the keyed-hash value to generate OTP. OTP is one-time-password. The thin-film transistor display presents a QR code message (or other two-dimensional code message) containing a product identity. When a customer scans a QR code message in an unclonable electronic device to be verified, the server receives a message to be verified. The server generates a one-off password according to the identity of a chip of the unclonable electronic device to be verified. The server verifies whether the one-off password is consistent with the one-time password in the unique identifier or certificate of authenticity by the server; if it is, the verification is successful; if not, the verification fails, and a warning message is sent to the code scanning device.

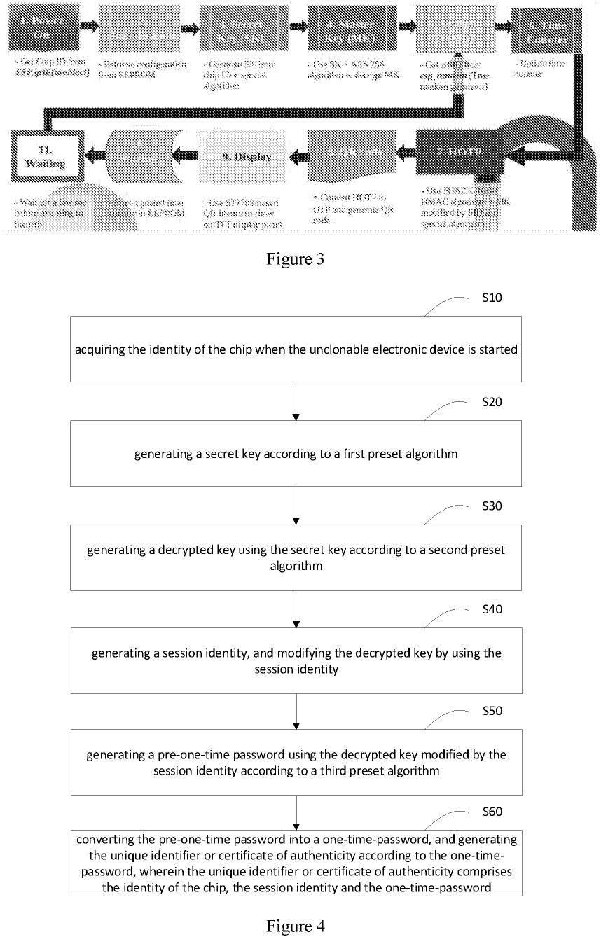

Referring to FIG. 3, it provides a flow chart of 11 key steps for the unclonable microcontroller program development. In brief, the Step 3 is used to get the master key (MK). Then, the MK, Session ID (SID) and Timer counter from Step3, 4, 5 and 6 are used to generate the HOTP or OTP. Furthermore, output of steps 5,6 and 7 are converted into QR code which is shown in the thin-film transistor (TFT) display. Finally, we store the updated time counter. After a few seconds, the system will run through Steps 5-10 again and again, indefinitely (until power off).

Referring to FIG. 4, the present disclosure provides some sample output of the TFT display of a unique identifier or certificate of authenticity. The method for generating a unique identifier or certificate of authenticity is applied to an unclonable electronic device which may be configured in commodities, suppliers providing the commodities or suppliers providing services. Referring to FIG. 1, the unclonable electronic device 100 comprises a an ESP32 or ESP32 compatible micro-controller 10 which has a chip with a unique chip identity and a thin-film transistor display 20.

The ESP32 or ESP32 compatible micro-controller is created and developed by Espressif Systems and manufactured by TSMC using their 40nm process. Its powerful chip is ESP32-D0WDQ6 made of dual core with CPU frequency of 240MHz, program memory of about 2MB and dynamic memory of nearly 300kB. It has built-in Wi-Fi and Bluetooth for wireless communication. Its specifications are obviously much better than those of other famous types of microcontrollers like Arduino Mega or Raspberry Pi boards, but its unit cost is just USD4-5, much lower than that of others which ranges from USD10-50.

The thin-film transistor display 20 may be a thin-film transistor (TFT) display.

In some embodiments, the thin-film transistor (TFT) display, IPS130 TFT color display is chosen as it has the resolution of 240x240 pixels (physical size of 2.5cm x 2.5 cm) and its unit cost is less than USD2.5.

A method for generating a unique identifier or certificate of authenticity provided according to an embodiment of the present application comprises the following steps:

Step S10: acquiring the identity of the chip when the unclonable electronic device is started.

It is worth noting that the identity of the chip is unique. Because the identity of the chip is unique and cloned into the hardware of the unclonable electronic device during the manufacturing process, our system program can only run in a particular ESP32 or ESP32 compatible micro-controller and so any counterfeiters cannot simply copy the machine codes from one authentic device to another other fake or authentic device without intensive efforts spent to carry out reverse engineering of the codes.

Step S20: generating a secret key according to a first preset algorithm.

The first preset algorithm is an SHA256 cryptographic algorithm.

Step S30: generating a decrypted key by using the secret key according to a second preset algorithm.

The second preset algorithm is an AES 256 cryptographic algorithm.

It is worth noting that one of the keys of the method for generating the authentication message lies in the decrypted key. The decrypted key is generated for instantaneous use from real-time using the AES256 cryptographic algorithm, but it is never shown, stored in nor transmitted through any media. Although the identity of the chip of individual ESP32 or ESP32 compatible micro-controller is not highly confidential (as it could be easily revealed from its Wi-Fi base MAC address), yet the security of the secret key of the unclonable electronic device is ensured by our specifically developed algorithm to generate it from the identity of the chip.

Step S40: generating a session identity, and modifying the decrypted key by using the session identity.

The session identity is a specific identifier, which is used to track the status and information of a specific program. In the embodiment of the present application, the decrypted key is modified through the session identity, so that the security of the subsequent generated pre-one-time password and one-time password is improved.

Step S50: generating a pre-one-time password using the decrypted key modified by the session identity according to a third preset algorithm.

The third preset algorithm is an SHA 256 based HMAC algorithm.

For authentication, hash-based message authentication code (HMAC) involves the use of a cryptographic hash function like SHA256 and a secret cryptographic key to simultaneously verify both the data integrity and authenticity of a message. An HMAC is a type of keyed hash function that can also be used in a key derivation scheme or a key stretching scheme. Instead of digital signatures with asymmetric cryptography which requires for a complex public key infrastructure, HMAC just employs a secret key shared just once between two parties. Then, it can be used to generate HMAC-based one-time password (the pre-one-time password) which will then be converted into human readable one-time password (OTP), rendering the so-called Open Authentication (OATH).

It is worth noting that, up to now, by using Google Scholar search and ChatGPT, no actual incidents of vulnerabilities for using SHA256 and AES256 cryptographic algorithms have been reported in the literature. Of course, it may be discovered in the future, and its security depends on the strength of the encryption key and proper implementation practices. Both SHA256 and AES256 are widely used and trusted cryptographic algorithms. However, it is important to note that their security relies not only on the algorithm itself but also on proper implementation, key management, and overall system design. Additionally, the choice of algorithm depends on the specific cryptographic requirements of the application, such as encryption, hashing, or digital signatures.

It is worth noting that, our algorithms to generate the unique identifier or certificate of authenticity from the identity of the chip could be modified with very little efforts and the unclonable electronic device could then be easily updated (with a new encrypted key as well) by the use of Over-the-air (OTA) technology of ESP32. Then, all the faked devices will immediately become obsolete as their generated OTP (pre-one-time password) will no longer be valid.

Step S60: converting the pre-one-time password into a one-time-password, and generating the unique identifier or certificate of authenticity according to the one-time-password, wherein the unique identifier or certificate of authenticity comprises the identity of the chip, the session identity and the one-time-password. A specific algorithm is used to extract values of the pre-one-time password (which is a kind HAMC value) at some predefined positions and convert them into a string of eight decimal number. The latter is appended to the session identity (as another string of eight decimal number) to form the one-time-password which is a human-readable decimal number. This one-time-password is different from the conventional one in its expiry mechanism. There is no expiry time pre-set for it and so it is valid for authentication until it or another one with newer session time is submitted to the server for authentication. However, the owner can easily make all previous one-time-passwords expired at once by the submission of a new one to the server.

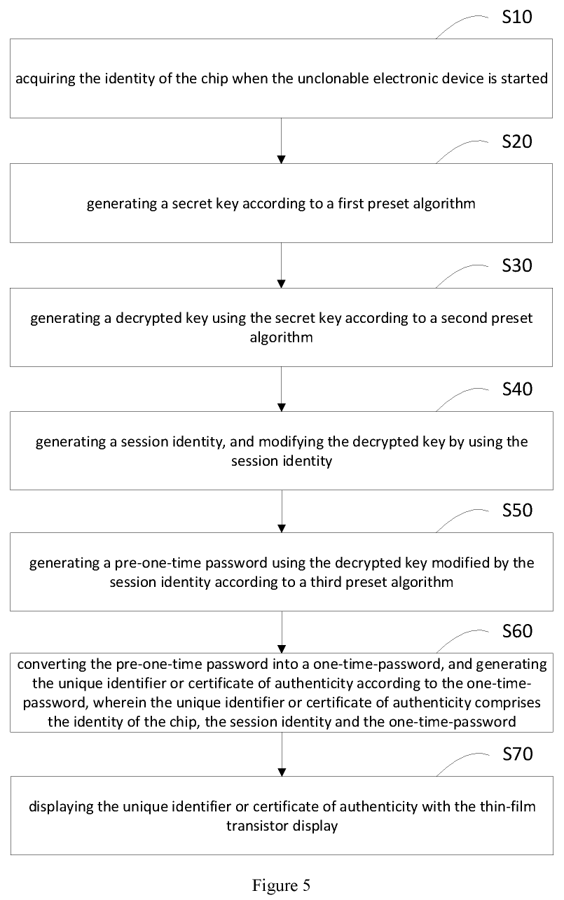

It is worth noting that, referring to FIG. 5, the method for generating the authentication message further comprises the following step S70. That is, after the step S60, the step S70 is executed.

S70: displaying the unique identifier or certificate of authenticity with the thin-film transistor display.

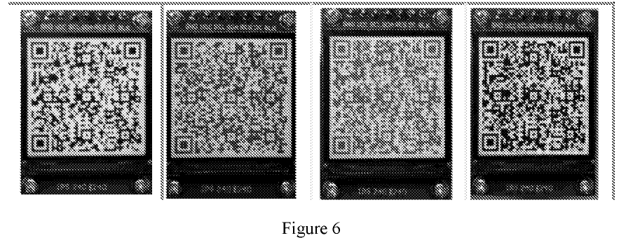

In some embodiments, the unique identifier or certificate of authenticity may be displayed in the form of two-dimensional codes, such as in the form shown in FIG. 6.

In some embodiments, the unique identifier or certificate of authenticity is displayed in the form of barcodes.

In some embodiments, the barcodes include any one of PDF417, Aztec and Data Matrix.

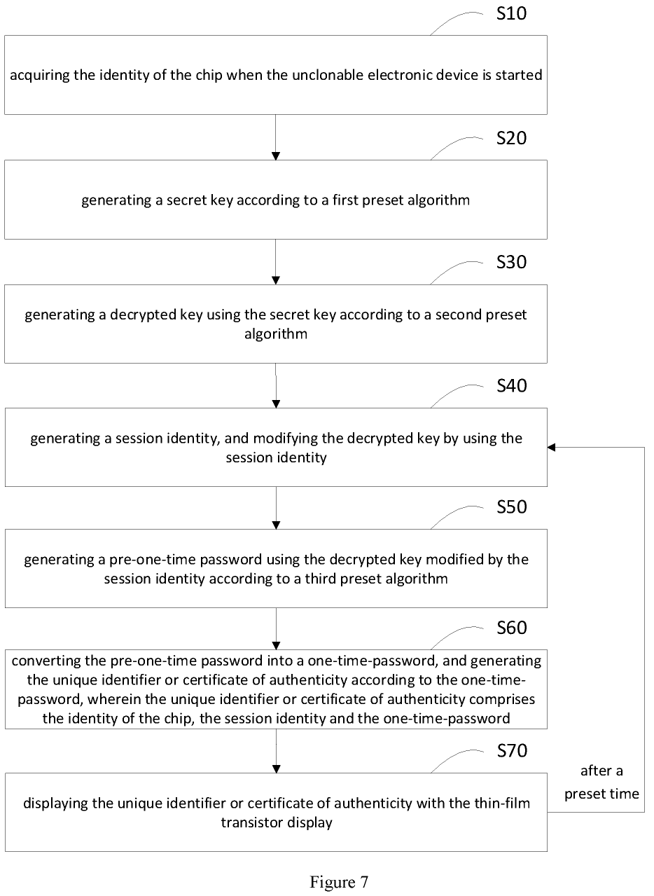

It is worth noting that, referring to FIG. 7, the method for generating the authentication message further comprises: after a preset time, executing the step of generating a session identity and modifying the decrypted key by using the session identity until the power of the unclonable electronic device is exhausted.

That is, after the preset time after the step S70, the step S40 is repeatedly executed, so that the generated one-time password is continuously updated, the security of the generated unique identifier or certificate of authenticity is improved, and the credibility of anti-counterfeit authentication of commodities or services is improved.

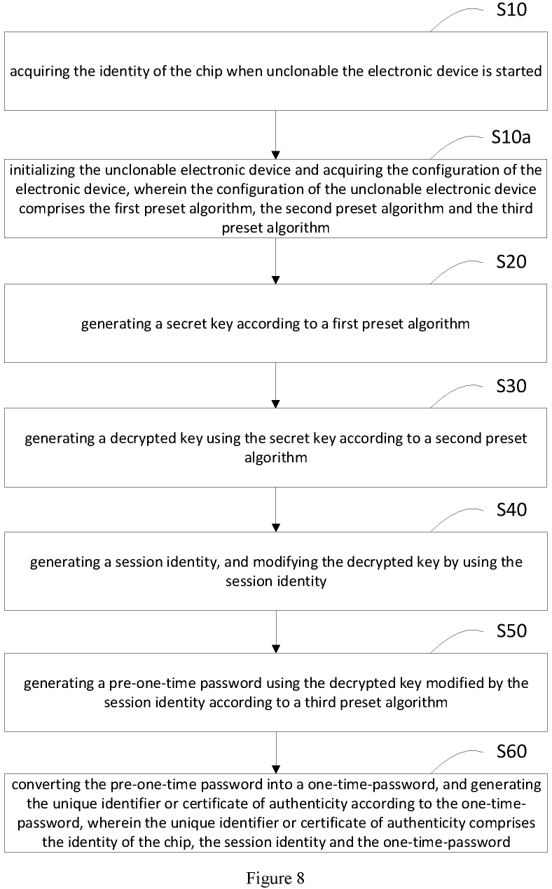

It is worth noting that, referring to FIG. 8, the method for generating the authentication message further comprises the following step S10a. That is, before the step S20, the step S10a is executed.

S10a: initializing the unclonable electronic device and acquiring the configuration of the unclonable electronic device, wherein the configuration of the unclonable electronic device comprises the first preset algorithm, the second preset algorithm and the third preset algorithm.

By initializing the unclonable electronic device, the interference to the configuration of the unclonable electronic device is prevented, and the first preset algorithm, the second preset algorithm and the third preset algorithm included in the configuration of the unclonable electronic device are improved to be in the best working state.

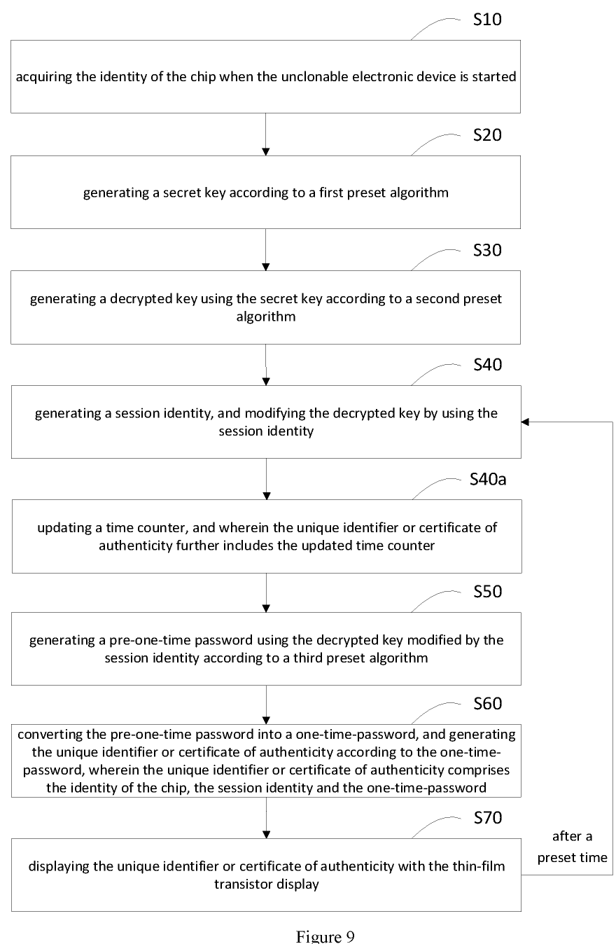

It is worth noting that, referring to FIG. 9, the method for generating the authentication message further comprises the following step S40a. That is, after the step S40, the step S40a is executed.

S40a: updating a time counter, and wherein the unique identifier or certificate of authenticity further includes the updated time counter.

Through the time counter, it can be ensured that the unique identifier or certificate of authenticity generated each time is unique and can be traced to a specific time point. In the process of anti-counterfeit authentication, the timeliness and authenticity of the unique identifier or certificate of authenticity can be confirmed according to the updated time counter. If the value of the time counter is not in line with the expectation, or the difference between the time stamp in the unique identifier or certificate of authenticity and the current time is too large, then the unique identifier or certificate of authenticity can be determined to be invalid. This mechanism increases the difficulty of counterfeiting and improves the security of anti-counterfeit authentication.

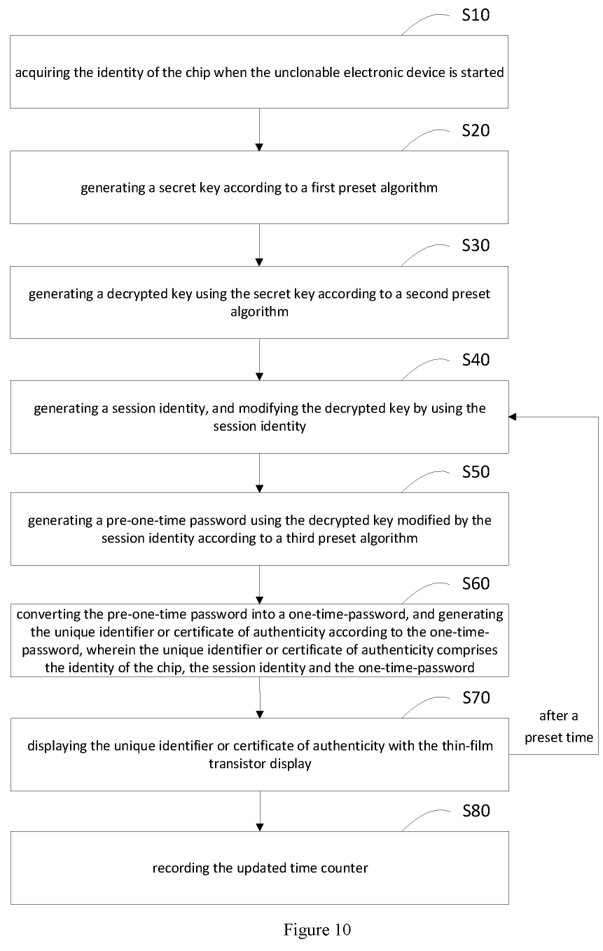

It is worth noting that, referring to FIG. 10, the method for generating the authentication message further comprises the following step S80. That is, after the step S70, the step S80 is executed.

Step S80: recording the updated time counter.

By recording the updated time counter, it is convenient for the subsequent anti-counterfeit authentication process.

It is worth noting that after generating the unique identifier or certificate of authenticity, for any commodity or service, consumers can perform anti-counterfeiting verification on the commodity or service by verifying the message to be verified in an unclonable electronic device since the unique identifier or certificate of authenticity is generated by the unclonable electronic device that may be configured in commodities, suppliers providing the commodities or suppliers providing services.

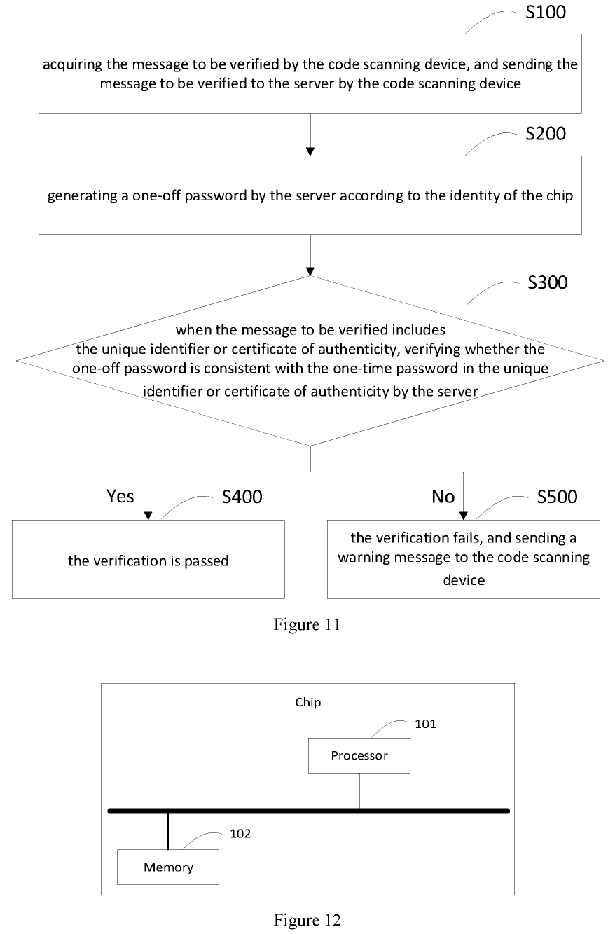

The message to be verified in the unclonable electronic device may be the unique identifier or certificate of authenticity generated by the unclonable electronic device configured in the authentic goods or authentic services, or the message to be verified in the unclonable electronic device may be forged by counterfeiters. By verifying the message to be verified, anti-counterfeiting verification can be performed on commodities or services. Specifically, referring to FIG. 11, the method for anti-counterfeiting verification comprises the following step:

Step S100: acquiring the message to be verified by the code scanning device, and sending the message to be verified to the server by the code scanning device.

The code scanning device may be a mobile phone, a tablet or even a phone watch of a consumer. For example, if the message to be verified includes a two-dimensional code, then any application (App) in the mobile phone of the consumer that is capable of code scanning can obtain the message to be verified by scanning the two-dimensional code.

The App used for code scanning may also be a specific mobile App we have developed to greatly simplify (or streamline) the process for the customers' usage, providing another layer of security against cheating.

Step S200: generating a one-off password by the server according to the identity of the chip.

When the message to be verified includes the unique identifier or certificate of authenticity, the unique identifier or certificate of authenticity includes the identity of the chip. The server can extract the configuration of the chip according to the identity of the chip, and then generate the one-off password by using the logic and method which are the same as those used to generate the one-time password by the unclonable electronic device.

Step S300: when the message to be verified includes the unique identifier or certificate of authenticity, verifying whether the one-off password is consistent with the one-time password in the unique identifier or certificate of authenticity by the server; if yes, then performing step S400, and if no, then performing step S500.

Step S400: the verification is passed.

Step S500: the verification fails, and sending a warning message to the code scanning device.

It is worth noting that in some embodiments, if the message to be verified does not include the unique identifier or certificate of authenticity, then it is determined that the verification fails and a warning message is sent to the code scanning device.

The warning message may warn consumers that the goods are counterfeit in any form, such as through pictures, words, sounds or the like.

It is worth noting that, in some embodiments, after the verification is passed, a serial number, retailer’s or current owner’s information (if registered), specifications and/or photo or the like about the goods or services may also be sent to the code scanning device.

The Embodiment 1 of the present application provides a method for generating a unique identifier or certificate of authenticity. As compared with the prior art, the present disclosure is found to possess the following advantages:
(i) Because the generated unique identifier or certificate of authenticity is based on the identity of the chip in the unclonable electronic device, the identity of the chip is unique and cloned into the hardware of the unclonable electronic device during the manufacturing process, and the final one-time password is generated according to the first preset algorithm, the second preset algorithm and the third preset algorithm, so any counterfeiters cannot simply copy the unique identifier or certificate of authenticity from one authentic device to another other fake or authentic device without intensive efforts spent to carry out reverse engineering of the unique identifier or certificate of authenticity.
(ii) The unclonable electronic device is very easy to develop and manufacture as its constituent hardware mainly consists of a micro-controller and a thin-film-transistor liquid-crystal display.
(iii) The generated unique identifier or certificate of authenticity is very simple for any mobile phone user to use (just scan the unique identifier or certificate of authenticity, e.g., QR code).
(iv) The unclonable electronic device is very cost-effective (around seven US dollars or less each) for authentication of individual high-end products or the retailer of low-price items.
(v) The generated unique identifier or certificate of authenticity is unclonable and highly secure as its underlying cryptographic algorithms (the first preset algorithm, the second preset algorithm, and the third preset algorithm) have never been cracked before.
(vi) There is no need to spend a huge amount of resources and research efforts to make continuous innovation for improvement of the anti-counterfeiting technology to fight against counterfeiting.

This embodiment of the present application provides a non-volatile computer readable storage medium, in which computer-readable instructions are stored, and the computer- readable instructions can execute the method for generating a unique identifier or certificate of authenticity in any of the above method embodiments.

FIG. 12 is a schematic view of the hardware structure of a chip for executing the method of generating the unique identifier or certificate of authenticity provided according to an embodiment of the present application. The unclonable electronic device 100 includes an ESP32 or ESP32 compatible micro-controller 10 and a thin-film transistor display 20 as shown in FIG. 1, and an ESP32 or ESP32 compatible micro-controller 10 has a chip with a unique chip identity. The chip may be provided with at least one processor 101 (FIG. 10 uses one processor as an example) and a memory 102 that are communicably connected via a bus or in other fashions.

The processor 101 is configured to provide calculation and control capabilities to control the chip to perform corresponding tasks. For example, the chip is controlled to perform any of the method of generating a unique identifier or certificate of authenticity according to embodiments herein-before.

The memory 102, as a non-volatile computer readable storage medium, may be configured to store non-volatile software programs, computer-readable instructions and modules, for example, the computer-readable instructions corresponding to the method of generating a unique identifier or certificate of authenticity according to the embodiments herein-before. The non-volatile software programs, computer-readable instructions stored in the memory 102, when executed, cause the processor 101 to perform the method of generating a unique identifier or certificate of authenticity according to any one of the method embodiments herein-before. Specifically, the memory 102 may include a high-speed random access memory, or include a non-volatile memory, for example, at least one disk storage device, a flash memory device, or another non-volatile solid storage device.

As can be clearly appreciated by those skilled in the art from the above description of the embodiments, the embodiments may be implemented by software plus a general hardware platform or, of course, by hardware. Based on this understanding, the essential part of the aforesaid technical solutions or the part thereof that contributes to the related art may be implemented in the form of a computer software product. The computer software product may be stored in a computer readable storage medium such as a read-only memory (ROM)/a random access memory (RAM), a magnetic disk, an optical disk or the like, and comprise a plurality of instructions that enable a computer device (which may be a personal computer, a server, or a network device) to execute the method(s) described in the individual embodiments or some portions of the embodiments.

Finally it shall be noted that, the above embodiments are only used to describe but not to limit the technical solutions of this application. Although this application has been detailed with reference to the above embodiments, those of ordinary skill in the art shall appreciate that modifications can still be made to the technical solutions disclosed in the above embodiments or equivalent substitutions may be made to some of the technical features, and the corresponding technical solutions will not essentially depart from the spirit and scope of the embodiments of this application due to such modifications or substitutions.

What is claimed is:

1. An unclonable electronic device for providing a unique identifier or certificate of authenticity, comprising:
an ESP32 or ESP32 compatible micro-controller having a unique chip identity, built-in Wi-Fi and Bluetooth capabilities; and
a thin-film transistor display with at least a resolution of 240x240 pixels:
wherein the unclonable electronic device further comprises software which is implementable on the micro-controller for generating a secret key using the SHA256 cryptographic algorithm and a specifically developed algorithm as based on the unique chip identity of the ESP32 or ESP32-compatible micro-controller.

2. The unclonable electronic device for providing a unique identifier or certificate of authenticity according to claim 1, wherein the software is updatable using over-the-air technology to enable modification of the SHA256 cryptographic algorithm and render counterfeit devices obsolete.

3. The unclonable electronic device for providing a unique identifier or certificate of authenticity according to claim 2, wherein the secret key is used for unlocking or decrypting an encrypted master key.

4. The unclonable electronic device for providing a unique identifier or certificate of authenticity according to claim 3, wherein the software is implemented on the micro-controller for encryption and decryption of the encrypted master key and product information using an AES256 cryptographic algorithm.

5. The unclonable electronic device for providing a unique identifier or certificate of authenticity according to claim 3, wherein the software utilizes a HMAC algorithm for generating a one-time password based on the decrypted master key, an instantaneous value of a time counter and a random number generated from the built-in true random number generator of the ESP32 or ESP32-compatible micro-controller.

6. The unclonable electronic device for providing a unique identifier or certificate of authenticity according to claim 5, wherein the thin-film transistor display presents a QR code message containing a product identity, the instantaneous value of the time counter, the random number, and the one-time password for authentication purposes.

7. The unclonable electronic device for providing a unique identifier or certificate of authenticity according to claim 6, wherein the unclonable electronic device further comprises an online server for recording device-related information, including the chip identity, the product identity, and the encrypted master key for each ESP32 or ESP32-compatible micro-controller.

8. The unclonable electronic device for providing a unique identifier or certificate of authenticity according to claim 7, wherein the online server generates the secret key to decrypt the encrypted master key during an authentication process using the chip identity and a specific algorithm.

9. The unclonable electronic device for providing a unique identifier or certificate of authenticity according to claim 7, wherein the online server authenticates a device by comparing a calculated one-time password with the submitted one-time password; wherein the online server calculates the calculated one-time password using the decrypted master key of the device together with the submitted product identity and the time counter.

10. The unclonable electronic device for providing a unique identifier or certificate of authenticity according to claim 9, wherein the online server provides further information about the product if the authentication is successful.
